(19) United States
(12) Patent Application Publication
(10) Pub. No.: US 2014/0344001 A1
(43) Pub. Date: Nov. 20, 2014

(54) MARKET FOR RESOURCES BASED ON REUSABLE USAGE POINTS AND USAGE PERIODS

(71) Applicant: Hewlett-Packard Development Company, L.P., Houston, TX (US)

(72) Inventors: Christina Aperjis, Palo Alto, CA (US); Filippo Balestrieri, Palo Alto, CA (US); Bernardo Huberman, Palo Alto, CA (US)

(73) Assignee: Hewlett-Packard Development Company, L.P., Houston, TX (US)

(21) Appl. No.: 13/896,497

(22) Filed: May 17, 2013

(51) Int. Cl. G06Q 10/06

(52) U.S. Cl. CPC G06Q 10/06314
USPC 705/7.24

(57) ABSTRACT

Example embodiments relate to a resource market based on reusable usage points and usage periods. In example embodiments, a system may maintain multiple resources provided by at least one resource provider, each resource being accessible by a user. The system may maintain multiple consecutive usage periods, during which the user can use resources of the multiple resources. The system may maintain, for the user, a number of usage points that may be exchanged by the user for usage of at least one of the multiple resources. Each usage point may be associated with a particular usage period of the multiple consecutive usage periods. The system may, for each usage point, allow the user to allocate, re-allocate or refrain from allocating the usage point to a particular resource during the usage period associated with the particular usage point.

### BACKGROUND

As data centers and cloud computing become more prevalent, entities are providing various resources to users via such data centers and/or clouds. The term “data center” may refer to a facility used to house computing resources such as computing devices and associated components (e.g., communication components, storage systems and the like). The term “cloud” may refer to computing resources provided by at least one data center that are offered together to users as a unified service. Using such a data center and/or cloud, an entity may provide resources to users such as applications (e.g., software as a service or “SAS”), services, operating systems (e.g., platform as a service or “PAS”), raw computing and/or storage resources (e.g., infrastructure as a service or “IAS”), digital content (e.g., digital music, movies, etc.) and the like.

### BRIEF DESCRIPTION OF THE DRAWINGS

The following detailed description references the drawings, wherein:

FIG. 1 is a block diagram of an example network setup, where a market for resources based on reusable usage points and usage periods may be used in such a network setup;

FIG. 2A depicts a diagram of how an example resource market system may work, specifically from a user's point of view;

FIG. 2B depicts a diagram of how an example resource market system may work, specifically from a user's point of view;

FIG. 3A depicts a diagram of how an example resource market system may work, specifically from a provider's point of view;

FIG. 3B depicts a diagram of how an example resource market system may work, specifically from a provider's point of view;

FIG. 4 is a block diagram of an example content market service for providing resources based on reusable usage points and usage periods;

FIG. 5 is a flowchart of an example method for providing resources based on reusable usage points and usage periods;

FIG. 6 is a block diagram of an example resource market computing device for implementing a resource market based on reusable usage points and usage periods; and

FIG. 7 is a flowchart of an example method for providing resources based on reusable usage points and usage periods.

### DETAILED DESCRIPTION

As described above, an entity may provide (e.g., via a data center or cloud) resources to users such as applications (e.g., software as a service or “SAS”), services, operating systems (e.g., platform as a service or “PAS”), raw computing and/or storage resources (e.g., infrastructure as a service or “IAS”), digital content (e.g., digital music, movies, etc.) and the like. In some scenarios, an entity may maintain (e.g., as part of the data center or cloud) a service that allows users to search, browse and/or view resources, select resources, pay for resources and access resources. One example of such a service is a mobile application store that allows users to search, browse and/or view mobile applications. Users can then select certain applications, pay for them, and then access the applications, for example, to download them.

Various services that allow users to access resources (e.g., mobile applications) facilitate a one-time purchase transaction between the user and the service, for example, where the user pays money to the service and the service then provides the resource to the user. The user may then own the resource and may use it forever, for example. The service may also pay some or all of the money paid by the user to the provider of the resource (e.g., if the provider is different than the entity that maintains the service). Various other services implement a license-based model, for example, where the user pays money to the service for the right to use a resource for a fixed period of time. In such implementations, the transaction to purchase a license for a period of time is still a one-time transaction, and the user (absent some trial period or malfunction of the resource) may not change his or her mind and switch to a different resource during the duration of the license. In other words, in both the case of the purchase and the license, once the one-time transaction has occurred, the transaction is final. Various services may allow a single provider to offer a “pool” of resources from which a user may select a resource to spend the user's money on. However, the pool includes resources from a single provider, and again, once the selection (i.e., the transaction) has occurred, the transaction is final. Various services may allow a user to purchase points (e.g., with dollars or other currency), and then the points may be used to purchase or license resources. With such services, when the points are exchanged for the resource the exchange is again final. In other words, in these scenarios, regardless of whether currency or points are used to purchase or license resources, the currency or points are expended or “lost” once the transaction is complete. Then later, to purchase or license additional or different resources, additional currency or points must be used.

The present disclosure describes a market for resources based on reusable usage points and usage periods. Such a market may allow users to purchase points that are assigned to and/or associated with a particular usage period. The market may allow users to allocate and reallocate their points to different resources provided by the market during the duration of the usage period to which the points are associated. If a user stops using a particular resource, points previously allocated to that resource may be de-allocated and may then become available to the user to allocate to other resources provided by the market. Resource providers may provide resources to the market. The market may monitor usage of resources by users (for example, at various granularities), and may pay resource providers for that usage. Throughout this disclosure, the term “resource” may be used to refer to resources provided to users via a market, resources such as applications (e.g., software as a service or “SAS”), services, operating systems (e.g., platform as a service or “PAS”), raw computing and/or storage resources (e.g., infrastructure as a service or “IAS”), digital content (e.g., digital music, movies, audio, video, etc.) and the like.

As it may be described in more detail below, the market of the present disclosure may allow for decoupling between various time periods, for example, the time period during which the user is committed to pay (e.g., in currency or points) for usage of resources and the time period during which a user is committed to usage of a particular resource. As another example, the market may allow for decoupling between the time period during which the user is committed to pay (e.g., in currency or points) for usage of resources and the time period for which a resource provider is paid for usage of a particular resource. Such decoupling may provide benefits over various other services (e.g., those described above).

The present disclosure may provide flexibility to both users and resource providers. For users, the market as described herein may allow a user to use various resources during a particular usage period. Users may be allowed to pay for general usage (e.g., during a usage period) of resources up front, and then may be allowed to explore various resources during the usage period. This may allow a user to avoid the hesitation of committing to resources because of uncertainty regarding features and capabilities, and instead may allow a user to learn about the features and capabilities of resources before using the resources for a long term. This flexibility may be especially useful in the case of enterprise resources (e.g., enterprise applications and raw computing and/or storage resources). Enterprise resources are generally very complex and expensive, and may need significant maintenance. With various other services that provide resources e.g., those discussed above), a user may hesitate to sink such a cost into an enterprise resource unless the user knows with a high degree of certainty that the resource works well and will get significant use. The present disclosure allows a user to proceed with minimal hesitation or without hesitation, for example, because the market may provide the user with many resource options.

Also for users, the present disclosure minimizes the number of transactions that are required between the user and individual resource providers. The user may purchase a number of usage points with a single transaction and then switch between using various resources with a simple selection. Another benefit to users may be that the market described herein allows users flexibility of use (described above) while still allowing users to adhere to budgeting periods, for example, as many companies must do. For example, a company may have to commit to an “enterprise software” budget for a fiscal quarter, year or the like. The market described herein may allow for such a commitment while still allowing the company flexibility with the resources it uses throughout the quarter, year or the like. Also for users, the present disclosure incentivizes and encourages innovative and quality resources by the resource providers. Because resource providers know that users may switch which resources they use at essentially any time, the providers may increase their efforts to deliver quality and innovative resources in order to gain and/or maintain business.

For resource providers, the present disclosure provides various benefits, for example, access to a large number of potential users. Developing or providing a resource may be costly, especially in the case of enterprise resources, as explained above. In addition to the reasons provided above, enterprise resources may require the provider to frequently update the resources based on customer requirements and/or industry standard requirements. Additionally, some resource providers may not have significant name recognition, reputation or good will. These factors may make it hard for some resource providers to break into a market, especially a market with large commercial customers, high transaction and/or negotiation costs and high entrance barriers like enterprise resources. The present disclosure may allow a resource provider to easily access many users (e.g., large enterprise customers), which may increase the expected return on the potentially costly investment of developing/providing a resource. Additionally, because the market may reduce or remove the hesitation of users to use the resources of the market (as explained above), a provider may secure customers, e.g., even without significant name recognition. As a consequence, more users may provide resources to the market and users may have access to a larger selection of resources. Additionally, the present disclosure may spur innovation among resource providers, first of all, because more resource providers are able to enter the market (e.g., higher expected return on investment), and secondly, because resource providers may see resources provided by other providers and may see ratings, reviews and/or usage statistics (more information provided below) of these other resources. Seeing successful and quality resources may incentivize providers to come up with similar, add-on or follow-up resources that are better, targeted toward a slightly different use, and the like.

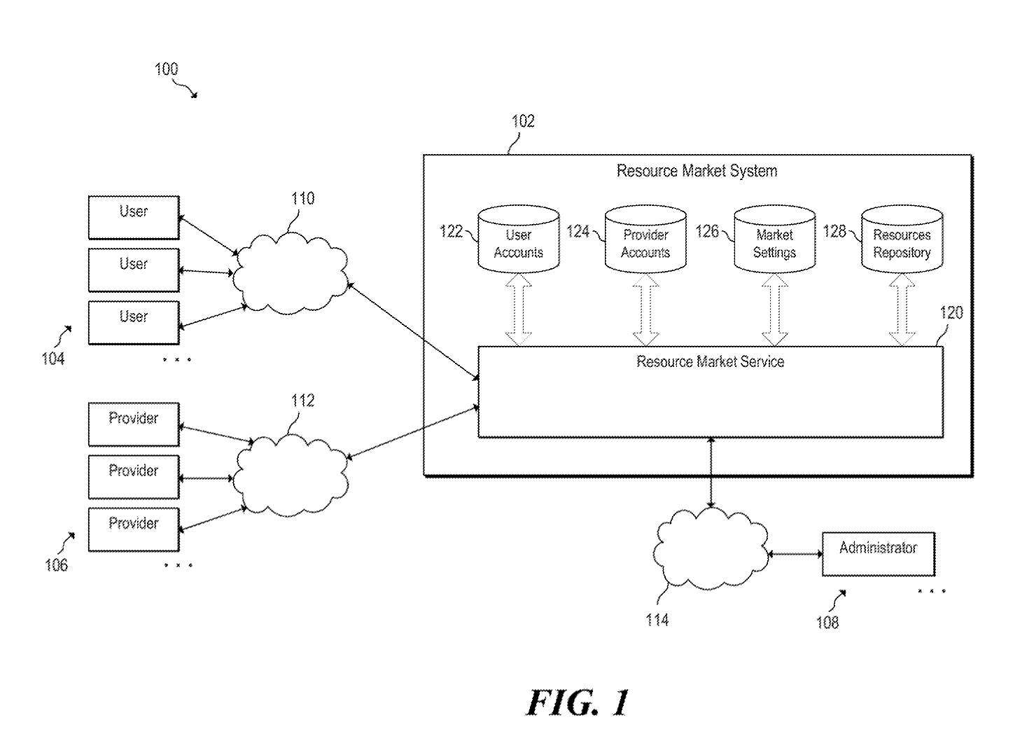

FIG. 1 is a block diagram of an example network setup 100, where a market for resources based on reusable usage points and usage periods may be used in such a network setup. Network setup 100 may include a resource market system 102, as described in more detail below. Network setup 100 may include a number of users 104, which may be in communication with resource market system 102, for example, via a network 110. Users 104 may communicate with resource market system 102 (e.g., with resource market service 120) to, among other things, access various resources provided by the resource market system 102, as described in more detail herein. Network setup 100 may include a number of providers 106, which may be in communication with resource market system 102, for example, via a network 112. Providers 106 may communicate with resource market system 102 (e.g., with resource market service 120) to, among other things, provide various resources to the resource market system 102, as described in more detail herein. Network setup 100 may include a number of administrators 108 (or simply “admins”), which may be in communication with resource market system 102, for example, via a network 114. Admins 108 may communicate with resource market system 102 (e.g., with resource market service 120) to, among other things, configure the resource market system 102, as described in more detail herein. Networks 110, 112, 114 may be a wired or wireless, and may include any number of hubs, routers, switches or the like. Networks 110, 112, 114 may be, for example, part of the Internet, at least one intranet and/or other type(s) of network(s). In some examples, two or more of networks 110, 112, 114 may be the same network.

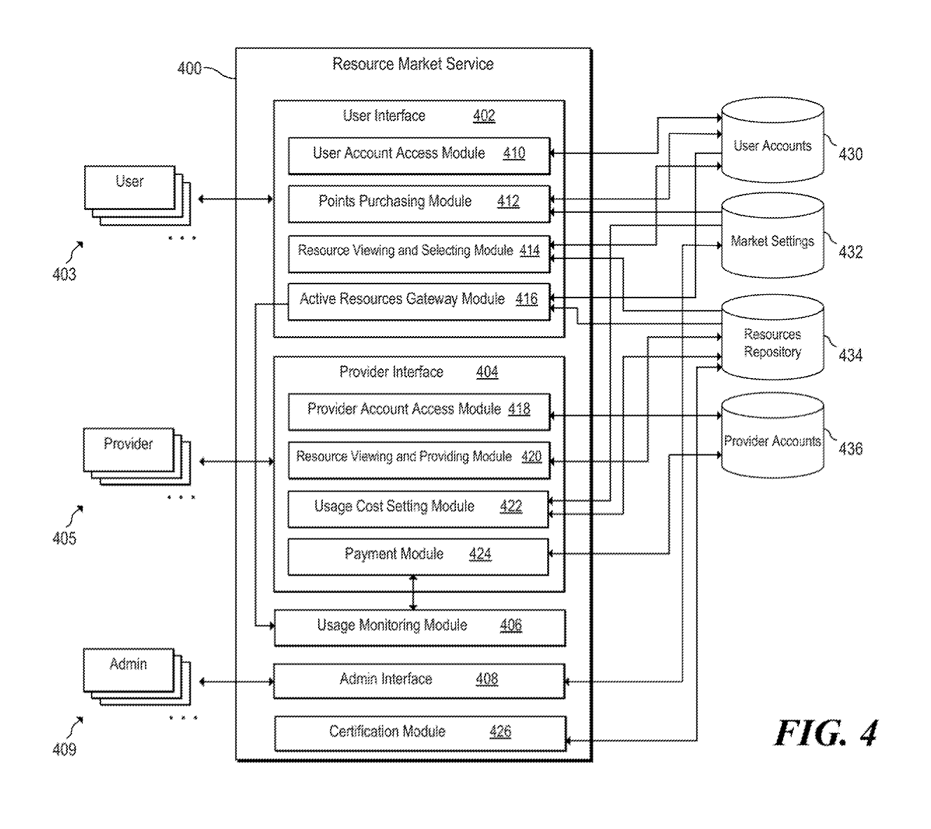

Resource market system 102 may include a resource market service 120. Resource market service 120 may maintain and provide resources based on reusable usage points and usage periods, as described in more detail below. Resource market service 120 may be implemented as at least one computing device, for example, any computing device accessible to users and providers over the Internet or some other network. In some examples, resource market service 120 may be implemented as more than one computing device, for example, computing devices that are in communication with each other (e.g., via a network). In these examples, the computing devices may be separate devices, perhaps geographically separate. The term “system” and/or “service” may be used to refer to a computing environment that includes one computing device or more than one computing device. It may be said that the resource market system 102 and/or the resource market service 120 may be offered in the “cloud” or as a cloud service, for example, because the system and/or service is provided by a number of computing devices and related components that are in communication with each other and presented as a unified service. More details of an example resource market service may be described below with regard to FIG. 4.

Resource market system 102 may include a number of repositories, for example, repositories 122, 124, 126, 128. The term repository may generally refer to a data store that may store digital information. Each of these repositories may include or be in communication with at least one physical storage mechanism (e.g., hard drive, solid state drive, tap drive or the like) capable of storing information including, for example, a digital database, a file capable of storing text, applications, media, code, settings or the like, or other type of data store. Repositories 122, 124, 126, 128 may be in communication (e.g., directly or via a network) with resource market service 120. In alternate examples, repositories 122, 124, 126, 128 may be included within resource market service 120. In some situations, two or more of the repositories 122, 124, 126, 128 may be implemented as the same single repository. In some situations, at least one of the repositories 122, 124, 126, 128 may be implemented as multiple repositories. User account repository 122 may store, for each user, various settings and pieces of information for the user. Provider account repository 122 may store, for each provider, various settings and pieces of information for the provider. Market settings repository 126 may store various settings and values that may be used by the resource market system. Resources repository 128 may store resources (e.g., software applications), information used to access resources, information related to particular resources, and the like.

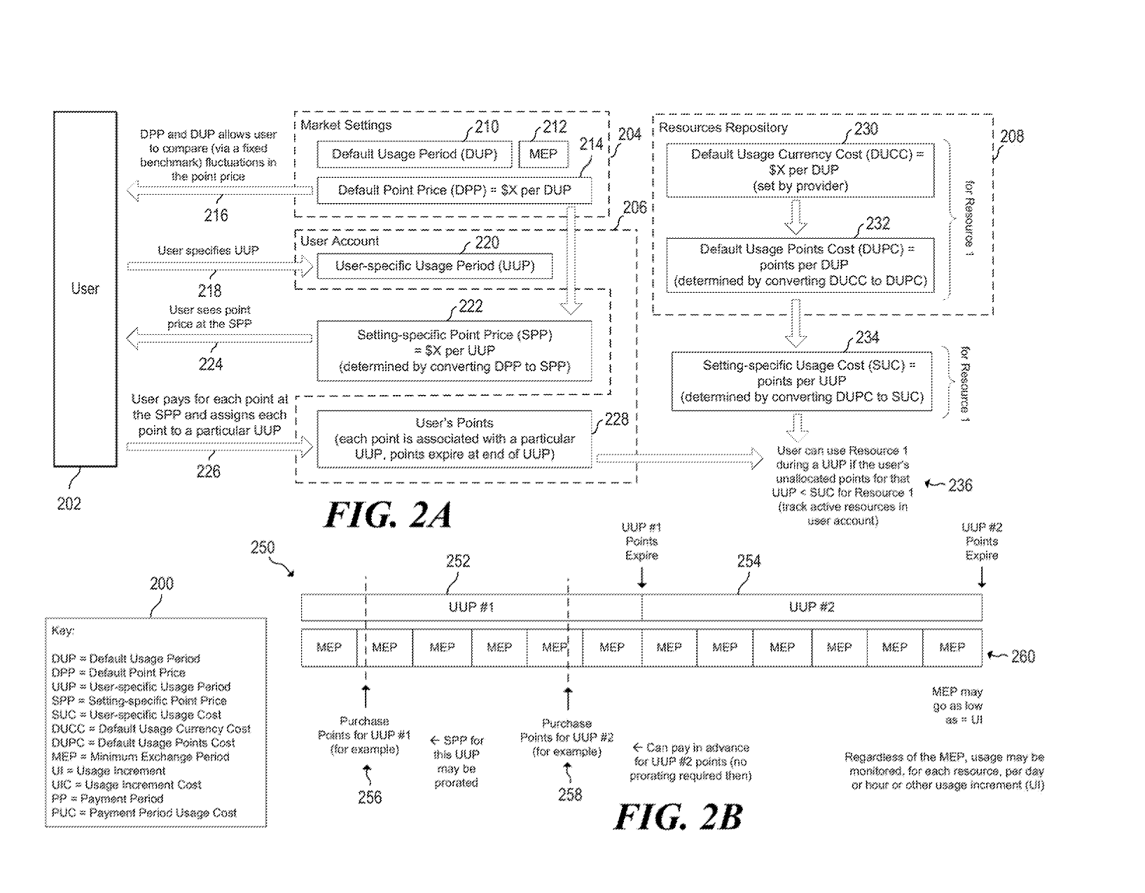

FIGS. 2A and 2B depict diagrams of how an example resource market system (e.g., 102) may work. Specifically, FIGS. 2A and 2B may depict how such a system may work from a user's point of view. To aid in providing an easy to understand description, FIG. 2B includes a key 200 that shows abbreviations for various terms. These terms will be defined in various descriptions provided below.

FIG. 2A depicts an example user 202 (e.g. similar to users 104 of FIG. 1). User 202 may be an individual, for example, acting on behalf of an entity such as a company. User 202 may be interested in paying a determined up-front price to use various resources provided by a resource market system (e.g., 102) during a usage period, while having the flexibility to vary which resources are used during such a usage period. FIG. 2A depicts various boxes that represent values, settings and the like that are maintained by the resource market system. Some of these boxes (e.g., 210, 212, 214) are depicted inside of dotted box 204 (entitled, “Market Settings”), which may indicate that these boxes are maintained in a market settings repository (e.g., 126). Some of these boxes (e.g., 220, 228) are depicted inside of dotted box 206 (entitled, “User Account”), which may indicate that these boxes are maintained in a user account repository (e.g., 122). Some of these boxes (e.g., 230, 232) are depicted inside of dotted box 208 (entitled, “Resources Repository”), which may indicate that these boxes are maintained in a resources repository (e.g., 128). Other boxes (e.g., 222, 234) not depicted inside of one of the dotted boxes of FIG. 2A may represent values, calculations and the like that are maintained by a resource market service (e.g., 120).

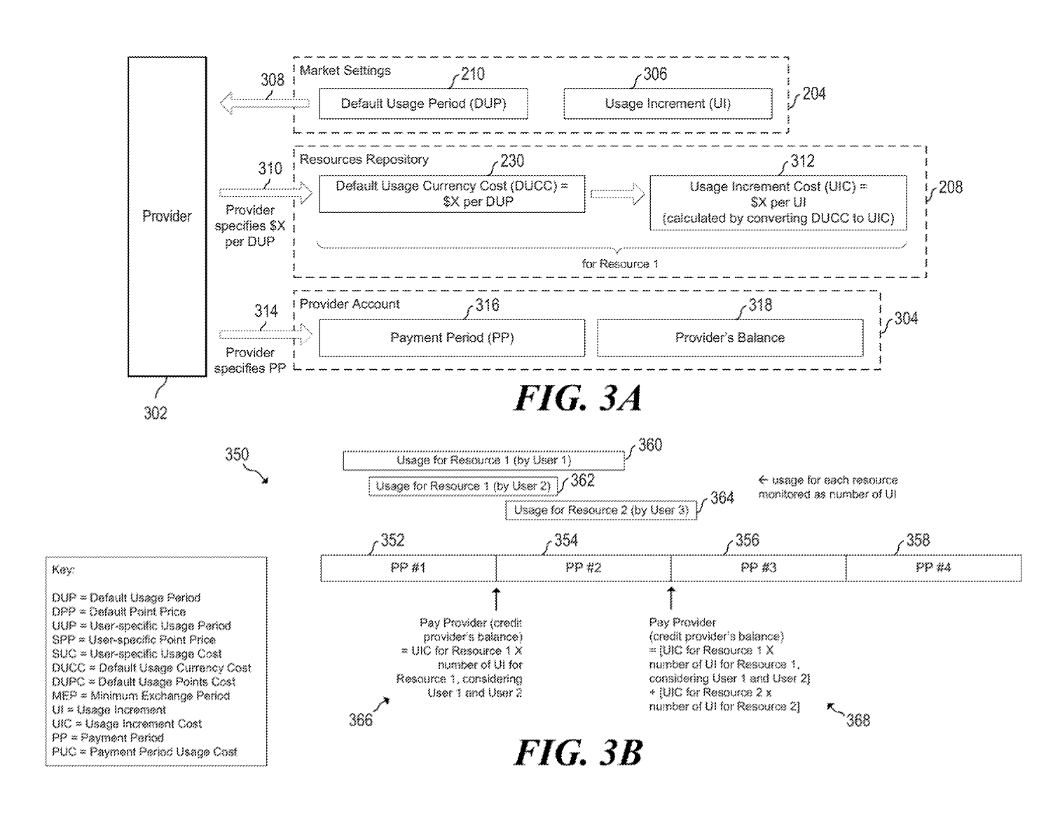

As shown in FIG. 2A, a market settings repository (e.g., indicated by dotted box 204) may maintain, among other values and/or settings, a default usage period (DUP) 206, a minimum exchange period (MEP) 212 and a default point price (DPP) 214. These values and/or settings may be set by a system administrator (e.g., 108) and may be values that are fixed (e.g., until changed by an admin) for all users and providers. Other values and/or settings maintained in the market settings repository may be described below with regard to FIG. 3A.

Default usage period (DUP) 210 may serve as a benchmark time period for various purposes in the resource market system. For example, the price of a point may be set (e.g., by an administrator) in relation to the DUP 210. As another example, the usage cost for a particular resource may be set (e.g., by a provider) in relation to the DUP (see FIG. 3A). The term “usage point” (or simply, “point”), throughout this disclosure, may refer to reusable points or tokens that may be exchanged (e.g., temporarily) for use of a resource. Each usage point, after being purchased by a user, may be associated with a particular usage period (e.g., UUP, as described below). The usage point may expire or become unusable at the end of the associated usage period. The term “usage period” may be used generally herein to refer to periods of time against which the usage of various resources may be monitored and/or against which the usability of points may be measured. Various specific types of usage periods may be described in more detail herein, for example, DUP, UUP, etc.

Default point price (DPP) 214 may be the price that an administrator sets for a single usage point with respect to the DUP 210. The price for a point may vary depending on the usage period to which the point is associated. Thus, DDP, which is associated with the DUP, may be one price, and SPP (discussed below), which is associated with the UUP, may be another price. The DDP and DUP may serve various purposes. Because the DUP is the same for all users and providers, admins may set the point price (DPP) with respect to a common benchmark (DUP). Additionally, the DPP and DUP may allow users to compare (e.g., see reference number 216), via a fixed benchmark, fluctuations in the point price, even if the users change their own personal usage periods (UUP), as described in more detail below.

In some situations, the resource market system may set the DPP such that the resource market system may make a profit for the services it provides. For example, the DPP may be increased (e.g., by certain %) beyond what may be required for the provider of resources to be perfectly compensated for use of their resources. In this respect, the resource market system may make a profit based on the purchase of each usage point in the system. In some situations, the resource market system may set the DPP so that the DPP varies depending on how many points the user purchases. For example, the user could receive a discount if the user purchases several points at the same time. These adjustments (e.g., increases and/or decreases) to the DPP may be made in a similar manner to the SPP 222.

As mentioned above, a user (e.g., 202) may specify (e.g., see reference number 218) the user's own personal usage period, referred herein to as the user-specific usage period (UUP). A user may specify the length of the UUP (e.g., 3 months, 4 months, 1 year, etc.) and the start and/or end dates of at least one UUP (e.g., the first UUP of the year starting on January 1). In some situations, the resource market system may impose some limitations on the user's ability to set the UUP. For example, the system may limit the granularity with which the user may specify the length of the UUP (e.g., increments of one day). Such a granularity may be related to the MEP (described more below) and/or may be equal to the MEP. In some situations, the resource market may determine various aspects of the UUP instead of the user. For example, the resource market may determine the length of the UUP and/or the start and/or end dates of at least one UUP.

The UUP's 220 for specific users may be maintained in a user account repository (e.g., indicated by dotted box 206). Such a user account repository may allow each user of the system to specify the user's own UUP, and the user account repository may maintain a separate UUP for each user. UUP 220 shown in FIG. 2A may represent the UUP for a single user, e.g., user 202. By maintaining a separate UUP for each user, the resource market system may allow a user to align the UUP with the user's budgetary or fiscal period, for example, a fiscal quarter, year or the like. Then, because a user may purchase a certain number of points for a particular UUP, the user may know (e.g., up front) the cost of using resources in the system for the user's fiscal quarter, year, etc. It should be understood that the UUP may not need to align with any particular fiscal time period, and a user may set the UUP to any time period the user desires (e.g., with some limitations).

Once the user (or the system) specifies the UUP, the resource market system may determine a setting-specific point price (SPP) 222. The resource market may determine the SPP 222, for example, by converting the DPP (associated with the UUP) to a SPP (associated with the UUP). This conversion may be performed, for example, by associating the ratio of price to time for DPP with the ratio of price to time for SPP. The SPP 222 may be displayed (e.g., see reference number 224) to the user, which may allow the user to determine a point price that is tailored to the user's specific UUP. In this respect, a user may be able to determine the exact amount of money the user may spend to use resources of the system for a user-specified period of time. As can be seen at reference number 226 in FIG. 2A, the user may purchase a number of points, and the user may pay for such points at the SPP. The user's points 228, once purchased, may be maintained or tracked in the user account repository (e.g., see reference number 206).

In some situations, the resource market system may use the SPP to allow the system to make a profit. For example, the SPP may be increased (e.g., by certain %) beyond what it may require for the provider of resources to be perfectly compensated for use of their resources. In this respect, the resource market system may make a profit based on the purchase of each usage point in the system. In some situations, the resource market system may set the SPP so that the SPP varies depending on how many points the user purchases. For example, the user could receive a discount if the user purchases several points at the same time.

When a user purchases points, the user may assign each point (or group of points) to a particular UUP. It should be understood that the term user-specific usage period (UUP) may be used herein in a flexible manner to refer to, depending on the context, either the user-defined UUP setting (e.g., 220) or time periods of potential resource use (e.g., reoccurring, consecutive, back-to-back time periods) that conform to the UUP setting. For example, AG. 2B shows a time diagram 250 (e.g., for a particular user 202) that includes two UUPs 252, 254 back to back. The time diagram 250 may be oriented on an imaginary x-axis that represents time, such that, from the left of the time diagram to the right of the time diagram, time ticks by. Each of UUP 252 and 254 may conform to a UUP setting for the user, which may determine the length of UUPs 252, 254, for example. Once UUP 252 expires, UUP 254 may start automatically. By referring to AG. 2B, it can be seen how points purchased by the user may be associated with a particular UUP. For example, the user may purchase some points that are associated with UUP 252. Then, during UUP 252, the user may use those points to exchange them for use of resources during UUP 252. As can be seen in AG. 2B, at the end of UUP 252, the points associated with UUP 252 may expire and/or become unusable. Then, points associated with UUP 254 may become active and may be used in a similar manner.

The resource market system may provide flexibility to the user regarding when the user purchases points in relation to the progress or timing of particular UUPs. For example, as can be seen in FIG. 2B at reference number 256, a user may purchase points for UUP 252 even though the user is purchasing the points after the start of UUP 252. In this situation, the price for these points (e.g., SPP) may be prorated to account for the portion of UUP 252 that has expired. As another example, as can be seen at reference number 258, a user may purchase points for a UUP (e.g., 254) before the UUP begins. In this example, the SPP for these points may not be prorated.

The following may describe how the resource market system may determine whether, for a particular UUP, a user may use a particular resource. A resources repository (e.g., 128) may store or maintain various resources and/or access information for various resources provided by the system. Providers may upload or provide resources and/or access to resources as described in more detail below. The resources repository (e.g., indicated by dotted box 208 in FIG. 2A) may maintain various values and/or settings for each resource, for example, DUCC 230 and DUPC 232.

Default usage currency cost (DUCC) may refer to the price (e.g., in currency such as dollars) to use a particular resource (e.g., resource 1) for the DUP. This price may be provided by the provider of the resource, as described in more detail below. Default usage points cost (DUPC) may refer to the points required by the system to be exchanged for use of the resource during the DUP. The system may determine DUPC by converting the DUCC to DUPC. This conversion may be possible, for example, because the DPP 214 is known (the points to currency ratio for the DUP). In some situations, the DUPC may not be determined based on a straight conversion from DUCC to DUPC. For example, the resource market system may determine the DUPC by adding a buffer between the price set by the provider and the price paid by the user. This may allow the entity that runs the resource market system to make a profit in exchange for the service it is offering. At this point, the DUPC may provide, e.g., to users browsing various resources, a price in points for resources that is associated with a fixed benchmark (DUP). This way, users may compare prices of various resources in relation to the DUP.

The resource market system may convert the DUPC, for each resource, to a setting-specific usage cost (SUC) 234, which may allow a user to see usage costs for resources where the usage cost is tailored to the user's specific usage period (UUP). The user may compare the SUC of various resources. The user may then select a particular resource to use (assuming the system determines that the user can use the particular resource).

The resource market system may determine whether a user, given the user's points 228, may use a particular resource (perhaps multiple resources) during a particular UUP. For example, for resource 1 as depicted in FIG. 2A, the resource market system may analyze the user's points 228 and the SUC 234 of resource 1. As can be seen at reference number 236, the user may use resource 1 during a particular UUP if the user's unallocated points for that UUP is greater than the SUC of resource 1. If the user decides to use resource 1 then a number of the user's points 228 equal (or approximately equal) to the SUC for resource 1 will be marked as allocated, and then the user will be allowed access to resource 1. At this point, the user may be allowed to use additional resources if the user's unallocated points (e.g., after points have been allocated for usage of resource 1) permit such usage. If the user allocates points to use additional resources, those points may similarly be marked as allocated.

If at some point the user indicates that the user would like to stop using a resource (e.g., resource 1), the points previously allocated to the resource may be marked as unallocated. At any time, unallocated points may remain unallocated (e.g., ready for future allocation), or they may be reallocated to other resources in the system to permit usage of the other resources. At any time, for a particular user, the total points (e.g., UCC) for the resources that the user has access to should be less than or equal to the user's points 228 (e.g., both allocated and unallocated points). In other words, the user may only use as many resources during a particular usage period as can be sSPPorted by the user's points 228 associated with that usage period.

In some examples and/or scenarios, the resource market system may sSPPort and allow for partial usage points. For example, the DUPC 232 and/or the SUC 234 may be stored and indicated as a decimal or fractional number (e.g., 4.75 usage points). Such partial usage points may be used, for example, if the conversion from DUCC to DUPC (and/or to UCC) does not result in an integer number. If partial usage points are allowed (e.g., for the DUPC and/or the SUC), then the user's points 228 may be allowed to be used in a partial manner, for example, such that a user may pay 4.75 points for the usage of a resource. In some examples and/or scenarios, integer numbers for points may be maintained, however. In such a case, if the conversion from DUCC to DUPC and/or SUC results in a non-integer value, the resource market system may, for example, round the values up (or down) to an integer value. As one specific example, if the conversion from DUCC to DUPC and/or SUC includes adding a buffer so that the resource market can make a profit, then the buffer may be added and then the final number may be rounded up to the next integer.

In some examples and/or scenarios, various usage points (e.g., in 228) may be associated with a usage restriction. A usage restriction may limit the way a usage point may be used. Various types of usage restrictions may be used by the system and a usage point may be associated with one or more usage restrictions. For example, some usage restrictions may limit the types of resources that the point may be used towards. Specifically, one usage restriction may require that the point be used towards resources of a particular category (e.g., software applications, storage, etc.). Another usage restriction may require that the point be used toward resources with a particular certification (explained in more detail below). Usage restrictions may be associated with points when users purchase the points. Users may be able to select which usage restrictions are associated with their points. Alternatively or in addition, usage restrictions may be imposed by the system (e.g., based on input from an administrator). Users may opt to purchase points with usage restrictions for a variety of reasons. For example, some users may want to protect themselves by only using resources with particular certifications. As another example, points may be priced differently based on the usage restrictions that are associated with the points. If the user's points (e.g., 228) are associated with usage restrictions, then the resources market system may check (e.g., at reference number 236) whether the user's points can be used toward a particular resource when the user attempts to select such a resource for use.

For each user, the resources to which the user currently has access may be tracked and indicated in the user account repository. When a user has “access” to a resource or when a user is authorized to “use” a resource, the resource market system may either allow the user to download and run the resource or may allow a user to access and/or run the resource via an online system (e.g., in the cloud). When access or use is revoked, the user may be unable to access the resource online and/or the user's downloaded copy of the resource may be unable to authenticate and may stop working. In some situations, each users' “usage history” may be tracked or maintained in the user account repository, which may allow the user to look back to see what resources the user has used in the past.

A user may change which resources the user uses from one UUP to the next UUP and within a particular UUP. If the user purchases enough points for a particular UUP, the user may use several resources during that UUP. However, if the user does not have enough unallocated points to use a particular resource during a UUP, the user may de-allocate points from a first resource and allocate those points to a second resource. In such a case, access to the first resource may be revoked and the user may be allowed access to the second resource. Thus, it can be seen that points are reusable during the UUP to which the points are associated. During any particular UUP, a user may use as many resources as the user's points for that UUP will allow.

The resource market system may limit how frequently a user may exchange resources during a UUP, by setting a minimum exchange period (MEP) 212. The MEP 212 may indicate, e.g., for all users, a minimum time period, where the user may only be allowed a single exchange (e.g., a single exchange overall or a single exchange per resource) during that time period. The MEP may reduce the load on the system that may result from users constantly switching which resources they are using. In some examples, and as shown in FIG. 2B, MEP's 260 may be aligned with the UUPs. For example, the MEP length may be related to and/or equal to the granularity specified by the system for UUPs such that each UUP can be made up for a number of MEP's, as shown in FIG. 2B. In some examples, the length of the MEP may go as low as the usage increment (UI). In some situations, the system may maintain multiple MEPs, for example, one MEP for each type of resource (e.g., assuming that resources are categorized into types). Then, the ability for a user to make an exchange related to a particular type of resource may be limited by the MEP of that particular type.

The resource market system may monitor (e.g., for each resource) the usage of that resource by various users. Usage for each resource may be monitored down to a specified granularity referred to as the usage increment (UI). The UI may be described in more detail below.

FIGS. 3A and 3B depict diagrams of how an example resource market system (e.g., 102) may work. Specifically, FIGS. 3A and 3B may depict how such a system may work from a provider's point of view. To aid in providing an easy to understand description, FIG. 3B includes the same key that is depicted in FIG. 2B. The terms in the key will be defined in various descriptions provided herein.

FIG. 3A depicts an example provider 302 (e.g., similar to providers 106 of FIG. 1). Provider 302 may be an individual, for example, acting on behalf of an entity such as a company. Provider 302 may provide resources to the resource market system (e.g., 102) and may get paid when any of the various users of the system use the resource. FIG. 3A depicts various boxes that represent values, settings and the like that are maintained by the resource market system. Some of these boxes (e.g., 210, 306) are depicted inside of dotted box 204 (entitled, “Market Settings”), which may indicate the same market settings repository as described in FIG. 2A. Some of these boxes (e.g., 230, 312) are depicted inside of dotted box 208 (entitled, “Resources Repository”), which may indicate the same resources repository as described in FIG. 2A. Some of these boxes (e.g., 316, 318) are depicted inside of dotted box 208 (entitled, “Provider Account”), which may indicate that these boxes are maintained in a provider account repository (e.g., 124).

As shown in FIG. 3A, a market settings repository (e.g., indicated by dotted box 204) may maintain a DUP 210 as explained above. The provider 302 may reference (e.g., see reference number 308) DUP 210, for example, to determine what the provider thinks the provider's resource is worth in relation to the DUP (e.g., a price for use during the DUP). The provider 302 may then specify (e.g., see reference number 310) a price (e.g., in currency such as dollars) per DUP for use of the provider's resource. The price may then be saved as the default usage currency cost (DUCC) 230 (e.g., the same DUCC as mentioned with regard to FIG. 2A) in the resources repository 208. The DUCC may represent the provider's valuation of their resource in relation to a fixed benchmark (DUP). Providers may be able to view DUCC's of other resources from other providers, for example, to see if the DUCC of their resources are in line with or more/less expensive than other resources.

The market settings repository 204 may maintain a usage increment (UI) 306. The UI may be set by a system administrator (e.g., 108) and may be a value that is fixed (e.g., until changed by an admin) for all users and providers. The resource market system may monitor (e.g., for each resource) the usage of resources by various users. Usage for each resource may be monitored down to a specified granularity that is the usage increment (UI). In some situations, there may be a relationship between the UI and the MEP (discussed above). For example, the MEP may be a multiple of the UI or may be the same as the UI. The resource market system may convert the DUCC 230 to a usage increment cost (UIC) 312. The UIC for each resource may be saved for later when usage for a particular resource is known. Then, the money due to the provider based on usage of the provider's resource may be calculated using the UIC and the usage statistics for the resource (e.g., a number of UI's).

The resource market system may allow the provider 302 to specify (e.g., see reference number 314) a payment period (PP) 316. The PP 316 may be maintained or indicated in the provider account repository (e.g., see reference number 304). The PP 316 may be a period of time (e.g., one month, one week, etc.) that indicates when the provider prefers to get paid for usage of resources provided by the provider. The PP 316 may operate in a manner that is similar to the UUP, in that the term payment period may be used in a flexible manner to refer to, depending on the context, either the provider-defined PP setting (e.g., 316) or time periods (e.g., reoccurring, consecutive, back-to-back time periods) that conform to the PP setting. The provider account repository may also maintain a provider's balance 318. When the resource market system determines that a provider should be paid for usage of the provider's resource(s), the resource market system may cause more money (e.g., digital indications of money) to be added to the provider's balance 318. The market resource system may offer an interface that allows the provider to withdraw money from the system to some other account.

FIG. 3B shows a time diagram 350 (e.g., for a particular provider 302) that includes four PPs 352, 354, 356, 358 back to back. The time diagram 350 may be oriented on an imaginary x-axis that represents time, such that from the left of the time diagram to the right of the time diagram, time ticks by. Each of PP's 352, 354, 356, 358 may conform to a PP setting for the provider, which may determine the length of PPs, for example.

The following may describe how usage may be monitored for various resources provided by a provider, and how a provider may get paid for such usage in relation to the provider's set PP. For the example of FIG. 3B, it will be assumed that the provider (e.g., 302) provides two resources (resource 1 and resource 2). Usage of these resources by various users may be monitored by the resource market system. The usage of the resources may be monitored at a granularity specified by the UI 306, for example. As one specific example, if the UI is set to one day, and if a single user uses the resource for 3 days, the usage for that resource may be 3 UI's (or just 3 UI). FIG. 3B shows usage indicators 360, 362, 364 of example usages of resource 1 and resource 2 by example users 1, 2 and 3. For example, indicator 360 may show that user 1 used resource 1 from a time associated with the left side of indicator box 360 to a time associated with the right side of indicator box 360. Indicators 362 and 364 show similar usages by users 2 and 3. As it can be seen in FIG. 3B, a user may use a resource for a time that spans more than one PP. Therefore, to determine the usage of a resource for a particular PP, the portion of the usage during a particular PP may be analyzed.

The resource market system may determine at the end of each PP (e.g., 352, 354) how much the provider should get paid for usage during that PP. For example, as shown by reference number 366, at the end of PP 352, the system may determine that the provider should get paid for the usage of resource 1 in the amount of UIC (e.g., 312) times the number of UI for usages 360 and 362 that are associated with PP 352. As another example, as shown by reference number 368, at the end of PP 354, the system may determine that the provider should get paid for the usage of resource 1 in the amount of UIC (e.g., 312) times the number of UI for usages 360 and 362 that are associated with PP 354. Additionally, at the end of PP 354, the system may determine that the provider should get paid for the usage of resource 2 in the amount of UIC (specific to resource 2) times the number of UI for usage 364 that is associated with PP 354. In some situations, the resource market system may alter the amount that the provider gets paid (e.g., at the end of a PP) based on various factors. For example, the amount of money due to a provider may be altered (e.g., on a percentage base) based on certifications for the resources (described more below), incentives, rewards and the like. Various types of information may be tracked for resource providers and may be stored or maintained in the provider account repository (e.g., 124), for example, dates and amounts for payments dispersed by the system, usage history for various resources provided by the provider, and the like.

FIG. 4 is a block diagram of an example resource market service 400 for providing resources based on reusable usage points and usage periods. Resource market service 400 may be similar to resource market service 120, for example. Resource market service 400 may facilitate some or all of the calculations, operations, interactions and the like shown in FIGS. 2A, 2B, 3A and 3B. Resource market service 400 may include a user interface 402, which may allow at least one user 403 to interact with the resource market service 400. Resource market service 400 may include a provider interface 404, which may allow at least one provider 405 to interact with the resource market service 400. Resource market service 400 may include a usage monitoring module 406, which may monitor the usage (by various users) of resources provided by the system. Resource market service 400 may include an admin interface 408, which may allow at least one admin 409 to interact with the resource market service 400. Resource market service 400 may include a certification module 426. Resource market service 400 may be in communication with a number of repositories 430, 432, 434, 436, which may be similar to repositories 122, 126, 128, 124, respectively. FIG. 4 may show a number of connections represented as arrows. It should be understood that the connections/arrows shown in FIG. 4 are just some example connections and more or less connections may be used in alternate examples and/or scenarios.

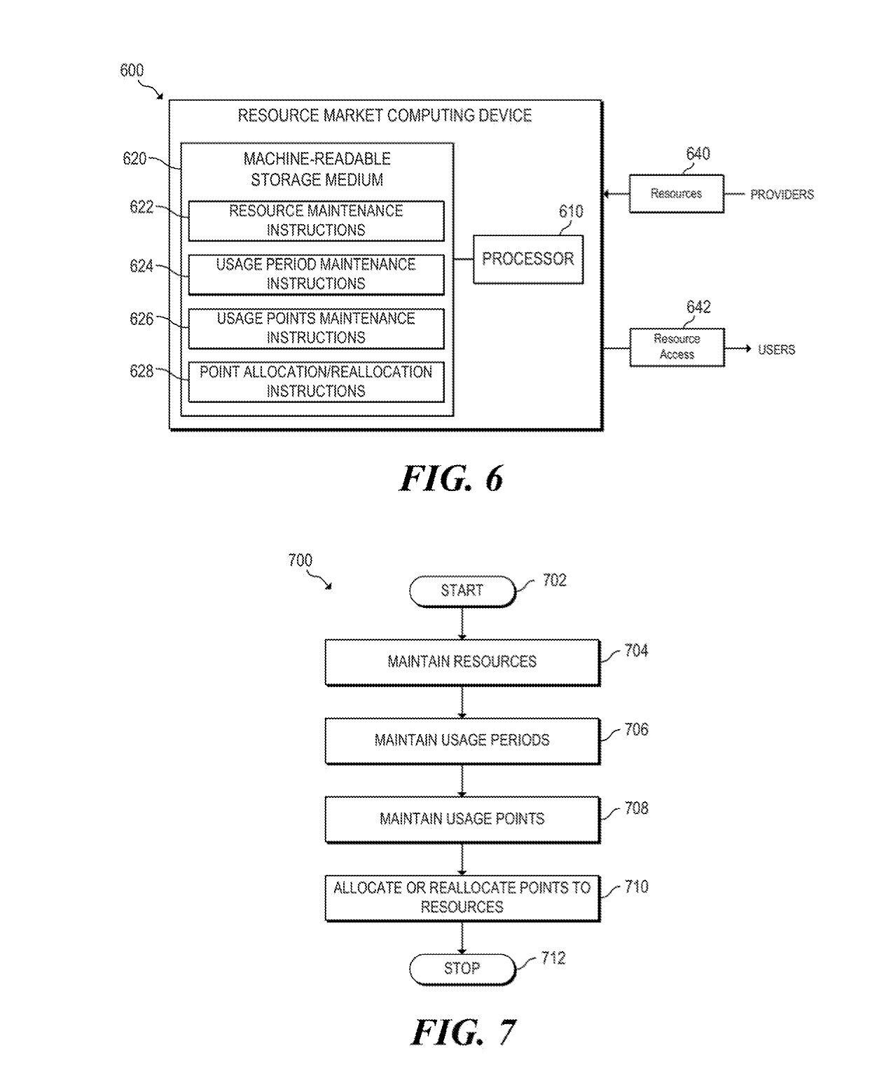

User interface 402 may include a number of modules, for example, modules 410, 412, 414, 416. These modules (and user interface 402 generally) may include a series of instructions encoded on a machine-readable storage medium and executable by a processor (e.g., processor 610 of FIG. 6) accessible by the content market service 400. In addition or as an alternative, these modules (and user interface 402 generally) may include one or more hardware devices including electronic circuitry for implementing the functionality described herein.

User account access module 410 may allow a user 403 to access the user's account (e.g., stored in user account repository 430). For example, a user may set the user's user-specific usage period (UUP). As another example, a user may check the number of usage points that the user has available to use. Points purchasing module 412 may allow a user 403 to purchase additional points. Module 412 may communicate with market settings repository 432 to determine the price of the points. Module 412 may communicate with user account repository 430 to store an updated indication of the user's points once the user purchases points.

Resource viewing and selection module 414 may allow a user to view resources that are provided by the system and available for use. Module 414 may communicate with resources repository 434 to view resources. Resource viewing and selection module 414 may allow a user 403 to view reviews and/or ratings of resources submitted (e.g., via module 414) by other users. Module 414 may allow a user 403 to view usage statistics (e.g., number of users, number of total hours used, etc.) for various resources. Module 414 may also allow the user to submit reviews and/or ratings of resources that the user has used. Module 414 may also allow the user to view certifications that may have been awarded for each resource. More details regarding certifications may be described below. Resource viewing and selection module 414 may allow a user to view the point price for each resource, for example, in relation to the DUP (DPP) and/or in relation to the UUP (the SPP), FIGS. 2A and 2B and the related description above describe DUP, DPP, UUP and SPP ire more detail. Module 414 may allow a user to select a resource for use, provided that the user's points allow for such usage. For example, the user's unallocated points for the desired usage period must exceed the SUC for the resource. The user's actively usable resources may be tracked or indicated in user account repository 430. The user's resource usage history may also be tracked in repository 430.

Active resources gateway module 416 may allow a user 403 to access (e.g., download or use via the cloud) the user's actively usable resources. Module 416 may communicate with user account repository 430 to determine which resources the user is currently able to access. Module 416 may communicate with resources repository 434 to deliver the resources and/or information needed to access the resources to user 403. Active resources gateway modules 416 may also communicate with usage monitoring module 406 to allow module 406 to monitor the usage of the resources by various users of the system.

Provider interface 404 may include a number of modules, for example, modules 418, 420, 422, 424. These modules (and provider interface 404 generally) may include a series of instructions encoded on a machine-readable storage medium and executable by a processor (e.g., processor 610 of FIG. 6) accessible by the content market service 400. In addition or as an alternative, these modules (and provider interface 404 generally) may include one or more hardware devices including electronic circuitry for implementing the functionality described herein.

Provider account access module 418 may allow a provider 405 to access the provider's account (e.g., stored in provider account repository 436). For example, a provider may set the provider's payment period (PP).

Resource viewing and providing module 420 may allow a provider to provide resources to the system and perhaps view resources that are provided by other providers. Module 420 may communicate with resources repository 434 to provide and/or view resources. Resource viewing and providing module 420 may allow a provider 405 to view reviews and/or ratings of resources submitted (e.g., via module 414) by various users of the system. Module 420 may allow a provider 405 to view usage statistics (e.g., number of users, number of total hours used, etc) for various resources. Module 420 may allow a provider to view the usage cost for each resource, for example, in relation to the DUP (DUCC). Module 420 may allow a provider to provide resources for use by users. To provide a resource, the provider may cause a resource (e.g., a software application) to be uploaded to the system (e.g., to the resources repository 434). Alternatively, the provider may provide information (e.g., a URL) that may be used to access the resource. Module 420 may allow a provider to request a certification for at least one of the provider's resources in the system. More details regarding certification may be described below.

Usage cost setting module 422 may allow a provider to set and/or modify the usage cost for the provider's resources in the system. For example, a provider may specify (e.g., see reference number 310 in FIG. 3A) a price per DUP (a DUCC) for each resource provided by the provider. Module 422 may communicate with market settings repository 432 to determine the DUP. Module 422 may allow a provider to view the usage cost of other resources provided by other providers.

Payment module 424 may allow a provider 405 to get paid for usage of resources provided by the provider. Payment module 424 may receive (e.g., from usage monitoring module 406) usage statistics for various resources in the system. Payment module 424 may communicate with provider account repository to determine which resources are provided by the particular provider. Payment module may compute the amount that the provider should be paid, for example, for a particular payment period (PP). Payment module 424 may communicate with provider account repository 436 to update (e.g., credit/add to) the provider's balance.

Usage monitoring module 406 may monitor the usage of various resources in the system. Usage monitoring module 406 may include a series of instructions encoded on a machine-readable storage medium and executable by a processor (e.g., processor 610 of FIG. 6) accessible by the resource market service 400. In addition or as an alternative, usage monitoring module 406 may include one or more hardware devices including electronic circuitry for implementing the functionality described herein. Usage monitoring module 406 may communicate with at least one active resources gateway module 416 (e.g., one per user) to receive usage information for various users and/or resources. In some examples, module 406 may communicate with resources repository 434 to determine which resources are available and/or to receive information about particular resources. Usage monitoring module 406 may monitor resource usage in a specified granularity (e.g., the UI, as explained in more detail above). Module 406 may provide usage information to at least one payment module 424, for example, one payment module per provider. Module 406 may communicate with resources repository 434 to store usage statistics about particular resources. Such usage statistics may be visible to users and/or providers, for example, via module 414 and/or module 420.

Admin interface 408 may allow an admin 409 to access a market settings repository 432 to add, remove and/or modify various settings and/or values for the resource market service system. For example, module 408 may allow an admin to set and/or modify the default point price (e.g., 214), and/or perhaps a conversion factor between DUCC 230 and DUPC 232. Admin interface 408 may include a series of instructions encoded on a machine-readable storage medium and executable by a processor (e.g., processor 610 of FIG. 6) accessible by the content market service 400. In addition or as an alternative, admin interface 408 may include one or more hardware devices including electronic circuitry for implementing the functionality described herein.

Certification module 426 may certify resources provided by the system. Certification module 426 may include a series of instructions encoded on a machine-readable storage medium and executable by a processor (e.g., processor 610 of FIG. 6) accessible by the content market service 400. In addition or as an alternative, certification module 426 may include one or more hardware devices including electronic circuitry for implementing the functionality described herein. Certification module 426 may allow an administrator (e.g., admin 409 via interface 408) to provide a certification for at least one resource provided by the system. In alternate examples and/or scenarios, certification module 426 may automatically provide (or deny) certifications, e.g., without input from an administrator. In some examples and/or scenarios, module 426 may communicate with an external (e.g., external to the content market system) certification service to provide resource or information about resources to the external service and to receive grants and/or denials of certifications in return.

The term certification or certify may be used to refer to an indication regarding the quality, capabilities and/or safety of a resource. Providers (e.g., 405) may request certifications for their resources in the system, for example, at least one certification for each resource. Likewise, if the certification module 426 communicates with an external certification service, such an external service may be a trusted service. Thus, providers may desire such certifications for their resources and users may prefer resources that are certified.

Certification module 426 may offer various types of certifications that may be available to certify a particular application. For example, different certifications may indicate different levels of performance. As another example, a certification may indicate that a resource is free of bugs, defects, viruses, spyware or the like. In some scenarios, a single resource may have multiple certifications. Certifications received for particular applications may be stored in resources repository 434 and may be visible to users and/or providers (e.g., via module 414 and/or module 420).

Certification module 426 may associate a price or charge with each type of certification. Providers may be required to pay such a price or charge to the resource market service 400 in order to obtain the certification(s). Costs for certifications granted to a particular provider may be subtracted from the provider's balance (e.g., 318). Alternatively, providers may pay for certifications as they are requested or received, or providers may pay for certifications via market entrance fees.

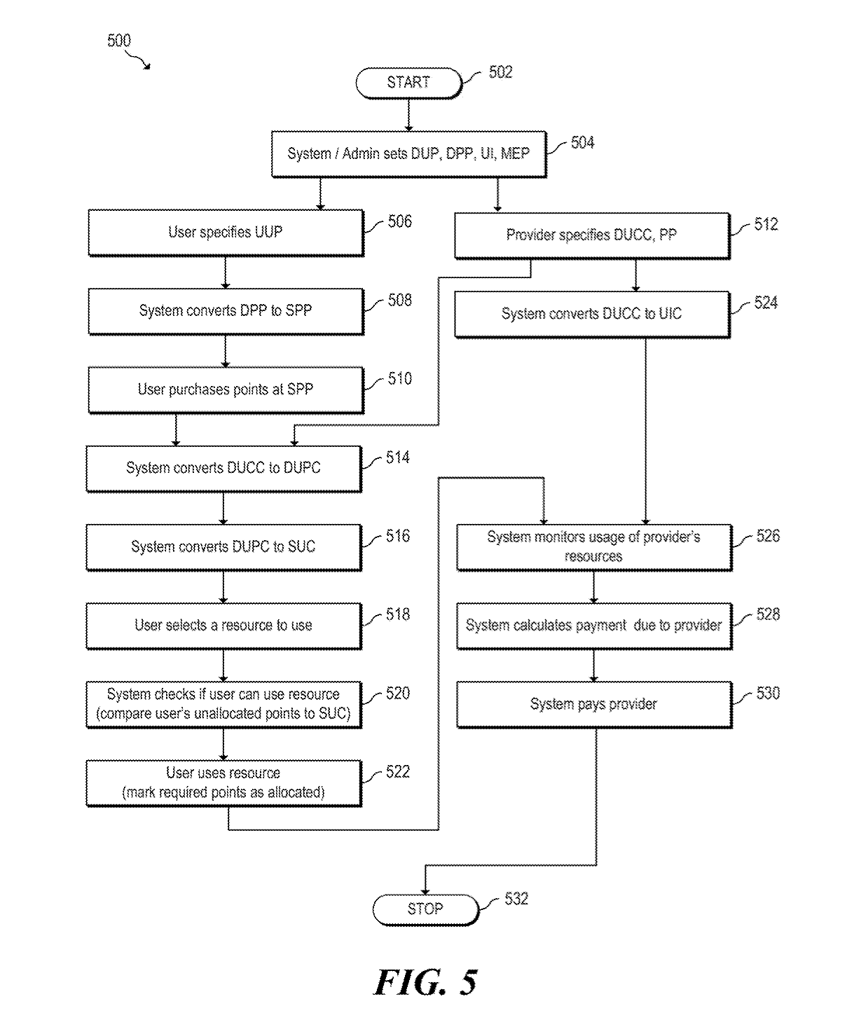

FIG. 5 is a flowchart of an example method 500 for providing resources based on reusable usage points and usage periods. Method 500 may be executed by a resource market system (or simply, system), for example, a system similar to resource market system 102 of FIG. 1. Alternatively, method 500 may be executed by any suitable computing device and/or system, for example, computing device 600 of FIG. 6. Method 500 may be implemented in the form of executable instructions stored on a machine-readable storage medium, such as storage medium 620, and/or in the form of electronic circuitry. In alternate examples of the present disclosure, one or more steps of method 500 may be executed substantially concurrently or in a different order than shown in FIG. 5. In alternate examples of the present disclosure, method 500 may include more or less steps than are shown in FIG. 5. In some examples, one or more of the steps of method 500 may, at certain times, be ongoing and/or may repeat.

Method 500 may start at step 502 and continue to step 504, where the system (e.g., via an administrator via module 408 of FIG. 4) may set various market settings and/or values (e.g., DUP, DPP, UI, MEP, etc.). Such values may be stored in a market settings repository such as 126, 204 or 432. At step 506, a user may specify (e.g., via user interface 402 of FIG. 4) a UUP, e.g., as indicated above by reference numbers 218 and 220 of FIG. 2A. At step 508, the system may convert DPP to SPP, e.g., as indicated above by reference number 222 of FIG. 2A. At step 510, the user may purchase (e.g., via user interface 402 of FIG. 4) a number of usage points at the SPP, e.g., as indicated above by reference numbers 226 and 228 of FIG. 2A. At step 512, a provider may specify (e.g., via provider interface 404 of FIG. 4) a DUCC and a PP, e.g., as indicated above by reference numbers 310, 230, 314 and 316 of FIG. 3A. At step 514, the system may convert DUCC to DUPC, e.g., as indicated above by reference numbers 230 and 232 of FIG. 2A. At step 516, the system may convert DUPC to SUC, e.g., as indicated by reference numbers 232 and 234 of FIG. 2A. At step 518, a user may view and select (e.g., via module 414) a resource to use. At step 520, the system may determine whether the user can use the resource, e.g., as indicated by reference number 236 of FIG. 2A. At step 522, if the system determines that the user can use the resource, the user may have access to the resource and may use the resource. Also at step 522, if the user is able to use the resource and selects to use it, the user's points required to use the resource may be marked as “allocated.”

At step 524, the system, for a particular provider's resource, may convert DUCC to UIC, e.g., as indicated by reference numbers 230 and 312 of FIG. 3A. At step 526, the system may monitor (e.g., via module 406) the usage of that resource by various users of the system. At step 528, the system may calculate payment (e.g., via module 424) that is due to the provider as a result of usage of the provider's resources, e.g., as shown by reference numbers 366 and 368 of FIG. 3B. At step 530, the system may pay the provider. Method 500 may eventually continue to step 532, where method 500 may stop.

FIG. 6 is a block diagram of an example resource market computing device 600 for implementing a resource market based on reusable usage points and usage periods. Resource market computing device 600 may be any computing device capable of being accessed by users and providers over the Internet or some other network. In some examples, resource market computing device 600 may actually be more than one computing device, in which case, multiple processors and/or machine readable mediums may be involved. More details regarding an example resource market system and/or resource market service may be described above, for example, with respect to resource market system 102 of FIG. 2, resource market service 120 of FIG. 2 and/or resource market service 400 of FIG. 4. In the example of FIG. 6, resource market computing device 600 includes at least one processor 610 and a machine-readable storage medium 620.

Processor 610 may be one or more central processing units (CPUs), CPU cores, microprocessors, and/or other hardware devices suitable for retrieval and execution of instructions stored in a machine-readable storage medium (e.g., 620). Processor 610 may fetch, decode, and execute instructions (e.g., instructions 622, 624, 626, 628) to, among other things, provide resources based on reusable usage points and usage periods. With respect to the executable instruction representations (e.g., boxes) shown in FIG. 6, it should be understood that part or all of the executable instructions included within one box may, in alternate examples, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within a computing device (e.g., 600), as shown in FIG. 6. In this situation, the executable instructions may be “installed” on the computing device. Alternatively, machine-readable storage medium 620 may be a portable (e.g., external) storage medium, for example, that allows a computing device (e.g., 600) to remotely execute the instructions or download the instructions from the storage medium. In this situation, the executable instructions may be part of an installation package. As described below, machine-readable storage medium 620 may be encoded with executable instructions to provide resources based on reusable usage points and usage periods.

Resource maintenance instructions 622 may maintain multiple resources provided by at least one resource provider. Each resource being accessible by a user. More details regarding maintaining resources may be described above, for example, with regard to resources repository 128, 208 and/or 434. Usage period maintenance instructions 624 may maintain multiple usage periods, for example, multiple consecutive usage periods, during which the user can use some of the multiple resources. More details regarding maintaining usage periods may be described above, for example, with regard to UUP 220 and/or UUP's 252, 254. Usage points maintenance instructions 626 may maintain, for the user, a number of usage points that may be exchanged by the user for usage of at least one of the multiple resources. Each usage point may be associated with a particular usage period of the multiple consecutive usage periods. Each usage point may be allocable by the user to a particular resource of the multiple resources. More details regarding usage points may be described above, for example, with regard to user's points 228 of FIG. 2A. Point allocation/reallocation instructions 628 may allocate and/or reallocate points to at least one resource. Instructions 628 may, for example, allow the user to specify or change which particular resource each usage point is allocated to during the usage period associated with the particular usage point.

FIG. 7 is a flowchart of an example method 700 for providing resources based on reusable usage points and usage periods. Method 700 may be executed by at least one computing device (e.g., 600) of a resource market system. Method 700 may be executed by other suitable computing devices and/or systems, for example, system 102 of FIG. 1. Method 700 may be implemented in the form of executable instructions stored on a machine-readable storage medium, such as storage medium 620, and/or in the form of electronic circuitry. In alternate examples of the present disclosure, one or more steps of method 700 may be executed substantially concurrently or in a different order than shown in FIG. 7. In alternate examples of the present disclosure, method 700 may include more or less steps than are shown in FIG. 7. In some examples, one or more of the steps of method 700 may, at certain times, be ongoing and/or may repeat.

Method 700 may start at step 702 and continue to step 704, where computing device 600 may maintain (e.g., via instructions 622) multiple resources provided by at least one resource provider. Each resource may be accessible by a user. At step 706, computing device 600 may maintain (e.g., via instructions 624) usage periods (e.g., multiple consecutive usage periods), for example, during which the user can use resources of the multiple resources. At step 708, computing device 600 may maintain (e.g., via instructions 626), for the user, a number of usage points. The usage points may be exchanged by the user for usage of at least one of the multiple resources. Each usage point may be associated with a particular usage period of the multiple consecutive usage periods. Each usage point may be allocable by the user to a particular resource of the multiple resources. At step 710, computing device 600 may allocate and/or reallocate (e.g., via instructions 628) usage points to resources. For example, computing device 600 may allow the user to specify or change which particular resource each usage point is allocated to during the usage period associated with the particular usage point. Method 700 may eventually continue to step 712, where method 700 may stop.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

1. A system for a resource market based on reusable usage points and usage periods, the system comprising:
at least one processor to:
maintain multiple resources provided by at least one resource provider, each resource being accessible by a user;
maintain multiple consecutive usage periods, during which the user can use resources of the multiple resources;
maintain, for the user, a number of usage points that may be exchanged by the user for usage of at least one of the multiple resources, wherein each usage point is associated with a particular usage period of the multiple consecutive usage periods, and wherein each usage point is allocable by the user to a particular resource of the multiple resources; and
for each usage point, allow the user to allocate, re-allocate or refrain from allocating the usage point to a particular resource during the usage period associated with the particular usage point.

2. The system of claim 1, wherein the multiple consecutive usage periods are uniquely configured by the user.

3. The system of claim 1, wherein the at least one processor is further to:
maintain, for each resource, a usage cost that indicates a cost in terms of usage points for the user to use the particular resource for any single usage period of the multiple consecutive usage periods; and
determine that the user can use a first resource of the multiple resources during a first usage period of the multiple consecutive usage periods based on a number of the usage points that are associated with the first usage period and unallocated being less than the usage cost of the first resource.

4. The system of claim 3, wherein the usage cost for each resource is related to a cost specified by the resource provider of the particular resource.

5. The system of claim 1, wherein the at least one processor is further to:
maintain a point price in terms of currency for each usage point; and
allow the user to purchase the usage points by interacting with the system to pay for each of the usage points at the point price.

6. The system of claim 1, wherein the at least one processor is further to determine an amount of money owed to the at least one resource provider based on usage, by the user, of the resources provided by the at least one resource provider.

7. The system of claim 1, wherein the at least one processor is further to:
maintain a usage increment;
monitor, for each resource of the multiple resources, usage by the user and/or other users as a number of usage increments;
maintain, for each of the at least one resource provider, multiple consecutive payment periods; and
determine, for each resource provider and for each of the resource provider's payment periods, an amount of money owed to the resource provider based on a number of usage increments associated with usage of the resource provider's resources during the payment period.

8. The system of claim 1, wherein the at least one processor is further to:
allow a first resource provider of the at least one resource provider to request certification of a first resource provided by the first resource provider;
associate a certification with the first resource in response to the first resource provider requesting certification; and
display to the user the certification while the user is viewing a representation of the multiple resources maintained by the system.

9. A method for providing resources based on reusable usage points and usage periods, the method comprising:
maintaining multiple resources, each resource being accessible by at least one user;
maintaining, for each of the at least one user, a usage period length;
maintaining, for a first user of the at least one user, multiple consecutive usage periods, each being of the usage period length associated with the first user;
providing, for each resource, a usage cost that indicates a cost for the first user to use the particular resource for the usage period length associated with the first user;
receiving input from the first user to purchase a number of usage points, each usage point being associated with one of the multiple consecutive usage periods, wherein each usage point is allocable to one resource of the multiple resources to count toward the usage cost for that resource during the usage period associated with the point; and
de-allocating, during a first usage period of the multiple consecutive usage periods, a first usage point of the usage points, the first usage point being associated with a first resource of the multiple resources, wherein the de-allocating causes access by the user to the first resource to be revoked.

10. The method of claim 9, further comprising reallocating, during the first usage period, the first usage point from the first resource to a second resource of the multiple resources, thereby allowing access to the second resource.

11. The method of claim 9, wherein allowing access to the second resource includes determining that the number of the first user's usage points that are allocated to the second resource is greater than or equal to the usage cost for the second resource.

12. The method of claim 9, further comprising:
maintaining a default usage period;
maintaining a default point price that indicates the price of a usage point in relation to the default usage period; and
converting the default point price to a setting-specific point price for the first user, wherein user purchases the usage points at the setting-specific point price.

13. The method of claim 9, further comprising:
maintaining a default usage period;
maintaining, for each of the multiple resources, a default usage cost that indicates the cost to use the resource for the default usage period; and
converting, for each of the multiple resources, the default usage cost to a setting-specific usage cost for the first user that indicates the cost to use the resource for the usage period length.

14. A machine-readable storage medium encoded with instructions executable by at least one processor of a system for providing resources based on reusable usage points and usage periods, the machine-readable storage medium comprising:
instructions to maintain multiple resources provided by at least one resource provider, each resource being accessible by a user;
instructions to maintain multiple consecutive usage periods, during which the user can use resources of the multiple resources;
instructions to maintain, for the user, a number of usage points that may be exchanged by the user for usage of at least one of the multiple resources, wherein each usage point is associated with a particular usage period of the multiple consecutive usage periods, and wherein each usage point is allocable by the user to a particular resource of the multiple resources; and
instructions to allow the user to allocate, de-allocate and/or reallocate each usage point to a particular resource during the usage period associated with the particular usage point.

15. The machine-readable storage medium of claim 14, further comprising instructions to allow the user to purchase the usage points.

16. The machine-readable storage medium of claim 14, further comprising instructions to monitor, for each resource of the multiple resources, usage of the resource by the user and other users, wherein usage is monitored according to a usage increment that is less than the length of any one of the multiple consecutive usage periods.

17. The machine-readable storage medium of claim 16, further comprising instructions to pay each of the at least one resource provider according to usage of resources provided by the particular resource provider, wherein the amount of each payment is based on usage relative to the usage increment.
